(19) United States
(12) Patent Application Publication
(10) Pub. No.: US 2020/0348130 A1
(43) Pub. Date: Nov. 5, 2020

(54) SYSTEM AND METHOD TO MEASURE BOW OF AN OBJECT

(71) Applicant: Apogee Enterprises, Inc., Minneapolis, MN (US)

(72) Inventors: Adam VanderStelt, Owatonna, MN (US); Tom Wojtowicz, Owatonna, MN (US); Steve Strusz, Owatonna, MN (US)

(21) Appl. No.: 16/865,615

(22) Filed: May 4, 2020

Related U.S. Application Data
(60) Provisional application No. 62/843,019, filed on May 3, 2019.

(51) Int. Cl. G01B 17/06

(52) U.S. Cl. CPC G01B 17/06

(57) ABSTRACT

An exemplary bow calculation tool is configured to receive first and second distance measurements associated with a unit under test from first and second ultrasonic ranging devices, respectively. The bow calculation tool is further configured to determine an effective radius based on a difference between the first and second distance measurements and a space between the first and second ultrasonic ranging devices. The bow calculation tool is further configured to determine a bow value associated with the unit under test based on the effective radius and a length of the unit under test.

### CROSS REFERENCE TO RELATED APPLICATION

This application claims priority to U.S. Provisional Patent Application No. 62/843,019 filed May 3, 2019, which is incorporated by reference herein, in its entirety, and for any purpose.

### BACKGROUND

Glass manufacturing technologies have continuously evolved to facilitate high volume production of sheets of glass in many shapes and sizes. As glass production techniques have improved, physical size tolerances have become tighter to ensure produced sheets of glass meet desired specification requirements. As such, sheets of glass are generally inspected as they proceed along the production line to detect physical defects. Conventional inspection methods for certain physical defects (e.g., bow or curvature of a sheet of glass) generally involve manual inspection of the sheets of glass. However, a drawback of the manual inspection methods is that they may slow the production process. Methods to increase production efficiency and throughput by removal of some manual inspection methods is desired.

### BRIEF DESCRIPTION OF THE DRAWINGS

FIG. 1 depicts a diagram illustrating a system to determine bow of a unit under test in accordance with embodiments of the disclosure.

FIGS. 2A-2C depict logic diagrams to determine bow of a unit under test in accordance with embodiments of the disclosure.

FIG. 3 depicts a flowchart for a method to determine bow of a unit under test in accordance with embodiments of the disclosure.

FIG. 4 depicts a flowchart for a method to determine bow of a unit under test in accordance with embodiments of the disclosure.

### DETAILED DESCRIPTION

Certain details are set forth below to provide a sufficient understanding of embodiments of the disclosure. It will be clear to one skilled in the art, however, that embodiments of the disclosure may be practiced without various aspects of these particular details. In some instances, well-known circuits, control signals, timing protocols, computer system components, and software operations have not been shown in detail in order to avoid unnecessarily obscuring the described embodiments of the disclosure.

This disclosure describes embodiments of a system to measure bow of an object. The described systems include use of ultrasonic ranging from multiple ultrasonic ranging devices to determine the bow of the object. Generally, the system operates by aligning at least two ultrasonic ranging devices along a first axis, and directing the at least two ultrasonic ranging devices toward a unit under test (UUT) along a second axis perpendicular to the first axis. Each of the at least two ultrasonic ranging devices may be configured to emit respective ultrasonic signals toward a respective section of the UUT, and receive reflections of the emitted ultrasonic signals from the respective section of the UUT. In some examples, each of the at least two ultrasonic ranging devices may be configured to determine a respective distance to the respective section of the UUT based on a respective elapsed time between transmission of the respective ultrasonic signals and receipt of the respective reflections of the ultrasonic signals. In other examples, each of the at least two ultrasonic ranging devices may be configured to determine the respective elapsed time, and another computing device may use the elapsed time to determine the respective distances. The two or more ultrasonic devices are spaced apart by a predetermined width. If the UUT is bowed, the respective distances determined by the two or more ultrasonic devices may be different. Using the known predetermined width and the known respective distances, the bow of the UUT may be determined using geometry-based calculations. In some examples, the UUT may be a pane of glass or other transparent material. Use of ultrasonic signaling may improve an ability to accurately measure bow of a pane of glass as compared with measurement systems that require physical contact with the pane of glass.

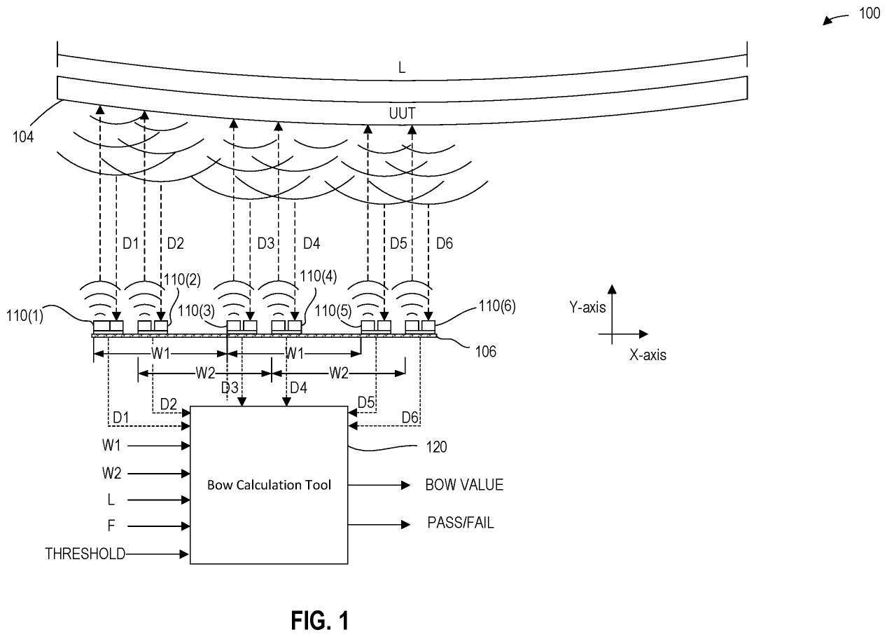

FIG. 1 depicts a diagram illustrating a system 100 to determine bow of a unit under test in accordance with embodiments of the disclosure. The system 100 includes a unit under test (UUT) 104, ultrasonic ranging devices 110(1)-(6), and a bow calculation tool 120. More or fewer of the ultrasonic ranging devices 110(1)-(6) may be included in the system 100 without departing from the scope of the disclosure. The UUT 104 may be any object, including a pane of glass or other transparent material, having a known length L.

The ultrasonic ranging devices 110(1)-(6) may each be configured to emit respective ultrasonic signals (e.g., waves) toward the UUT 104 and receive reflections of the emitted ultrasonic signals off of the UUT 104. Each of the ultrasonic ranging devices 110(1)-(6) may be mounted on a 160 such that they are aligned along an X-axis and with emission and reception oriented along a Y-axis (e.g., toward the UUT 104). In some examples, each of the ultrasonic ranging devices 110(1)-(6) may be affixed to secure structure or mount 106. In some examples, the ultrasonic ranging device 110(1) and the ultrasonic ranging device 110(3) may be spaced apart by a first width W1 along the X-axis, and the ultrasonic ranging device 110(3) and the ultrasonic ranging device 110(5) may be spaced apart by the W1 width along the X-axis. Similarly, the ultrasonic ranging device 110(2) and the ultrasonic ranging device 110(4) may be spaced apart by a second width W2 along the X-axis, and the ultrasonic ranging device 110(4) and the ultrasonic ranging device 110(6) may be spaced apart by the W2 width along the X-axis. In some examples, the W1 width and the W2 width are equal. In other examples, the W1 width and the W2 width are different. Each of the ultrasonic ranging devices 110(1)-(6) may include an ultrasonic signal transmitter and an ultrasonic signal receiver. Each of the ultrasonic ranging devices 110(1)-(6) may be configured to transmit respective ultrasonic signals using a different frequency or timing to differentiate from respective ultrasonic signals emitted from others of the ultrasonic ranging devices 110(1)-(6). Each of the ultrasonic ranging devices 110(1)-(6) may be configured to determine a respective distance D1-D6 to the UUT 104 based on a respective elapsed time measured from emission of the respective ultrasonic signals to receipt of the reflections of the respective ultrasonic signals from (e.g., off of) the UUT 104. In some examples, the D1-D6 distances may be expressed as units of time, which may be later converted to a physical distance.

The bow calculation tool 120 may be implemented as instructions stored on a computer readable medium that are executed by a processor to perform the bow value calculation, in some examples. In other examples, the bow calculation tool 120 may be implemented in a programmable logic controller, hardware, or any combination thereof. The bow calculation tool 120 may receive the D1-D6 distances, the W1 width, the W2 width, the L length of the UUT 104, an adjustment factor F, and a threshold value indicating a bow limit. In some examples, the threshold value may represent a maximum acceptable bow of the UUT 104 (e.g., in examples where little or no bow is desired). In some examples, the threshold value may represent a minimum acceptable bow of the UUT 104 (e.g., in examples where at least some bow of the UUT 104 is desired). In yet other examples, the threshold value may include two values (e.g., lower and upper values) to provide a range of acceptable bow of the UUT 104 (e.g., in examples where bow within a particular range is desired). The bow calculation tool 120 may use the D1-D6 distances, the W1 width, the W2 width, the L length of the UUT 104, the F factor, and the threshold value to determine a bow value of the UUT 104 and whether the bow value of the UUT 104 passes or fails to meet the threshold value.

In operation, the UUT 104 may be placed in an emission path of the ultrasonic ranging devices 110(1)-(6) along the Y-axis. In some examples, the UUT 104 may be stationary. In other examples, the UUT 104 may move along the X-axis. Each of the ultrasonic ranging devices 110(1)-(6) may emit respective ultrasonic signals (e.g., waves) toward the UUT 104. In some examples, emission of the respective ultrasonic signals by the ultrasonic ranging devices 110(1)-(6) may be temporally sequential in some predefined order. In other examples, emission of the respective ultrasonic signals by the ultrasonic ranging devices 110(1)-(6) may be contemporaneous or simultaneous. Contemporaneous or simultaneous emission may be used to determine accurate relative distances D1-D6 when the UUT 104 is moving in the X-axis direction or the Y-axis direction. Each of the ultrasonic ranging devices 110(1)-(6) may receive reflections of the respective emitted ultrasonic signals off of the UUT 104. Each of the ultrasonic ranging devices 110(1)-(6) may be configured to determine a respective distance D1-D6 to the UUT 104 based on a respective elapsed time measured from emission of the respective ultrasonic signals to receipt of the reflections of the respective ultrasonic signals from (e.g., off of) the UUT 104. In some examples, the D1-D6 distances may be expressed as units of time, which may be later converted to a physical distance.

The bow calculation tool 120 may determine a bow value of the UUT 104 based on the D1-D6 distances, the W1 width, the W2 width, the L length of the UUT 104 and the F factor. The F factor may be used to adjust the bow value based on errors caused by movement of the UUT 104, the L length of the UUT 104, the W1 width or the W2 width, or other factors in implementation of the system. The bow value of the UUT 104 may be compared against the threshold value to determine whether the bow value of the UUT 104 is within an acceptable range.

In one specific example, the bow calculation tool 120 may use the D1, D3, and D5 distances to determine a first bow value and/or may use the D2, D4, and D6 distances to determine a second bow value. The first bow value and/or second bow value may be independently compared against the threshold value to determine a pass or fail of the UUT 104.

In another specific example, the bow calculation tool 120 may use the D1, D3, and D5 distances to determine a first effective radius and may use the D2, D4, and D6 distances to determine a second effective radius. In some examples, the bow calculation tool 120 may use the D3 distance and an average of the D1 and D5 distances to determine the first effective radius. In some examples, the bow calculation tool 120 may use the D4 distance and an average of the D2 and D6 distances to determine the second effective radius. The bow calculation tool 120 may be further configured to determine an average of the first effective radius and the second effective radius to provide a combined effective radius. The combined effective radius may be used to determine the bow value of the UUT 104. Assuming a constant arc defined by the UUT, an effective radius is a radius of a circle that would be formed if the L length of the UUT was extended until both ends met.

It is appreciated that the system 100 may be configured with fewer or more than 6 of the ultrasonic ranging devices 110(1)-(6) without departing from the scope of the disclosure. For example, the system 100 may include only two of the ultrasonic ranging devices 110(1)-(6) to determine the bow of the UUT 104. In another example, the system 100 may only include a single one of the ultrasonic ranging devices 110(1)-(6) that is configured to determine two distances spaced apart by a predetermined time, with the UUT 104 moving along the X-axis direction at a predetermined rate of speed, where the predetermined time and the predetermined rate of speed are used to determine the width W1 or W2 values. In another example, the system 100 may include four of the ultrasonic ranging devices 110(1)-(6) divided into pairs for calculating respective bow or effective radius values.

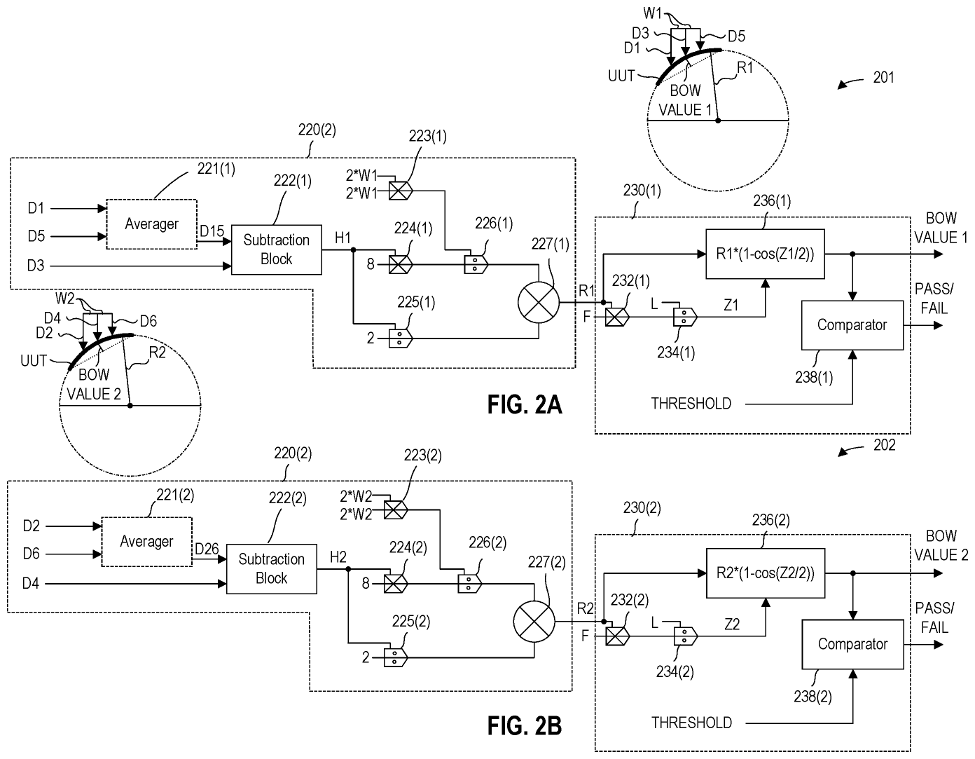

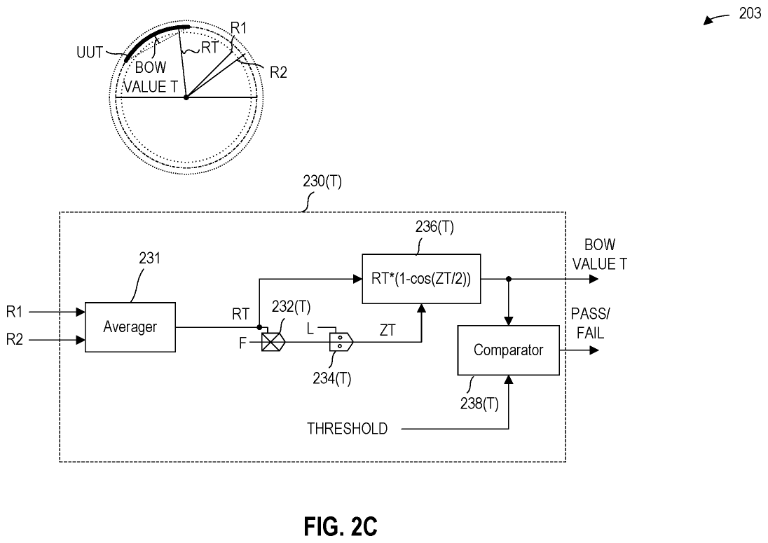

FIGS. 2A-2C depicts logic diagrams to determine bow of a UUT (e.g., the UUT 104 of FIG. 1) in accordance with embodiments of the disclosure. FIG. 2A depicts a logic diagram 201 to determine a first bow value of the UUT. FIG. 2B depicts a logic diagram 202 to determine a second bow value of the UUT. FIG. 2C depicts a logic diagram 203 to determine a combined bow value of the UUT. The bow calculation tool 120 of FIG. 1 may implement one or more of the logic diagrams 201, 202, or 203 of FIGS. 2A-2C, respectively, in some examples.

The logic diagram 201 of FIG. 2A may include an effective radius calculator 220(1) configured to calculate a first effective radius R1 and optionally may include a bow value calculator 230(1). The effective radius calculator 220(1) may include an optional averager 221(1), a subtraction block 222(1), a multiplier 223(1), a multiplier 224(1), a divider 225(1), a divider 226(1), and an addition block 227(1). The optional averager 221(1) may be configured to determine an average of the D1 and D5 distances to provide the D15 distance. In other examples that do not include the optional effective radius calculator 220(1), the logic diagram 201 may instead use one of the D1 or D5 distance as the D15 distance. The subtraction block 222(1) may be configured to subtract the D15 distance from the D3 distance to provide a first height H1. The multiplier 223(1) may be configured square two multiplied by the W1 width the multiplier 224(1) may be configured to multiply the H1 height times 8. The divider 226(1) may be configured to divide the output of the multiplier 223(1) by the output of the multiplier 224(1). The divider 225(1) may be configured to divide the height H1 by two (2). The addition block 227(1) may be configured to add the output of the divider 226(1) to the output of the divider 225(1) to provide the first effective radius R1.

The bow value calculator 230(1) may include, a multiplier 232(1), a divider 234(1), a bow value calculation block 236(1), and a comparator 238(1). The multiplier 232(1) may be configured to multiply the first effective radius R1 by the factor F. The F factor may account for errors caused by the setup of the system, including errors in calculating the distances D1-D6, the length L of the UUT, or combinations thereof. In some examples, the F factor may be set to one. The divider 234(1) may be configured to the length L by the output of the multiplier 232(1) to provide a Z1 value. The bow value calculation block 236(1) may be configured to receive the first effective radius and the Z1 value, and may multiply the first effective radius R1 by a cosine of half of the Z1 value subtracted from one (1) to provide the first bow value. The comparator 238(1) may be configured to compare the first bow value to a threshold value to determine a pass/fail of the UUT. That is, if the first bow value falls outside a range defined by the threshold value, the comparator 238(1) may set the pass/fail signal to indicate that the UUT failed. Otherwise, the comparator 238(1) may set the pass/fail signal to indicate that the UUT passed. In some examples, the comparator 238(1) may only set the pass/fail signal to pass when the first bow value falls below or is equal to the threshold value. In other examples, the comparator 238(1) may only set the pass/fail signal to pass when the first bow value is equal to or exceeds the threshold value. In yet other examples, the comparator 238(1) may only set the pass/fail signal to pass when the first bow value is within a range defined by the threshold value.

The logic diagram 202 of FIG. 2B may include an effective radius calculator 220(2) configured to calculate a second effective radius R2 and may optionally include a bow value calculator 230(2). The effective radius calculator 220(2) may include an optional averager 221(2), a subtraction block 222(2), a multiplier 223(2), a multiplier 224(2), a divider 225(2), a divider 226(2), and an addition block 227(2). The optional averager 221(2) may be configured to determine an average of the D2 and D6 distances to provide the D26 distance. In other examples that do not include the optional effective radius calculator 220(2), the logic diagram 202 may instead use one of the D2 or D6 distance as the D26 distance. The subtraction block 222(2) may be configured to subtract the D26 distance from the D4 distance to provide a second height H2. The multiplier 223(2) may be configured square two multiplied by the W2 width the multiplier 224(2) may be configured to multiply the H2 height times 8. The divider 226(2) may be configured to divide the output of the multiplier 223(2) by the output of the multiplier 224(2). The divider 225(2) may be configured to divide the height H2 by two (2). The addition block 227(2) may be configured to add the output of the divider 226(2) to the output of the divider 225(2) to provide the second effective radius R2.

The bow value calculator 230(2) may include, a multiplier 232(2), a divider 234(2), a bow value calculation block 236(2), and a comparator 238(2). The multiplier 232(2) may be configured to multiply the second effective radius R2 by the factor F. The divider 234(2) may be configured to the length L by the output of the multiplier 232(2) to provide a Z2 value. The bow value calculation block 236(2) may be configured to receive the second effective radius R1 and the Z2 value, and may multiply the second effective radius R2 by a cosine of half of the Z2 value subtracted from one (1) to provide the second bow value. The comparator 238(2) may be configured to compare the second bow value to the threshold value to determine a pass/fail of the UUT. That is, if the second bow value falls outside a range defined by the threshold value, the comparator 238(2) may set the pass/fail signal to indicate that the UUT failed. Otherwise, the comparator 238(2) may set the pass/fail signal to indicate that the UUT passed. In some examples, the comparator 238(2) may only set the pass/fail signal to pass when the second bow value falls below or is equal to the threshold value. In other examples, the comparator 238(2) may only set the pass/fail signal to pass when the second bow value is equal to or exceeds the threshold value. In yet other examples, the comparator 238(2) may only set the pass/fail signal to pass when the second bow value is within a range defined by the threshold value.

Thus, as previously described, either the logic diagram 201 or the logic diagram 202 may be configured to provide respective first and second bow values and pass/fail signals using three ultrasonic ranging devices. In a third example, the logic diagram 203 of FIG. 2C includes a bow value calculator 230(T) that is configured to use an average of the first effective radius provided from the effective radius calculator 220(1) and the second effective radius provided from the effective radius calculator 220(2) to determine a combined bow value T. The bow value calculator 230(T) may include an averager 231, a multiplier 232(T), a divider 234(T), a bow value calculation block 236(T), and a comparator 238(T). The averager 231 may be configured to determine an average of the first effective radius provided from the effective radius calculator 220(1) and the second effective radius provided from the effective radius calculator 220(2) to provide an averaged radius RT. The multiplier 232(T) may be configured to multiply the averaged effective radius RT by the factor F. The divider 234(T) may be configured to the length L by the output of the multiplier 232(T) to provide a ZT value. The bow value calculation block 236(T) may be configured to receive the averaged effective radius RT and the ZT value, and may multiply the averaged effective radius RT by a cosine of half of the ZT value subtracted from one (1) to provide the combined bow value T. The comparator 238(T) may be configured to compare the combined bow value T to the threshold value to determine a pass/fail of the UUT. That is, if the combined bow value T falls outside a range defined by the threshold value, the comparator 238(T) may set the pass/fail signal to indicate that the UUT failed. Otherwise, the comparator 238(T) may set the pass/fail signal to indicate that the UUT passed. In some examples, the comparator 238(T) may only set the pass/fail signal to pass when the combined bow value T falls below or is equal to the threshold value. In other examples, the comparator 238(T) may only set the pass/fail signal to pass when the combined bow value T is equal to or exceeds the threshold value. In yet other examples, the comparator 238(T) may only set the pass/fail signal to pass when the combined bow value T is within a range defined by the threshold value.

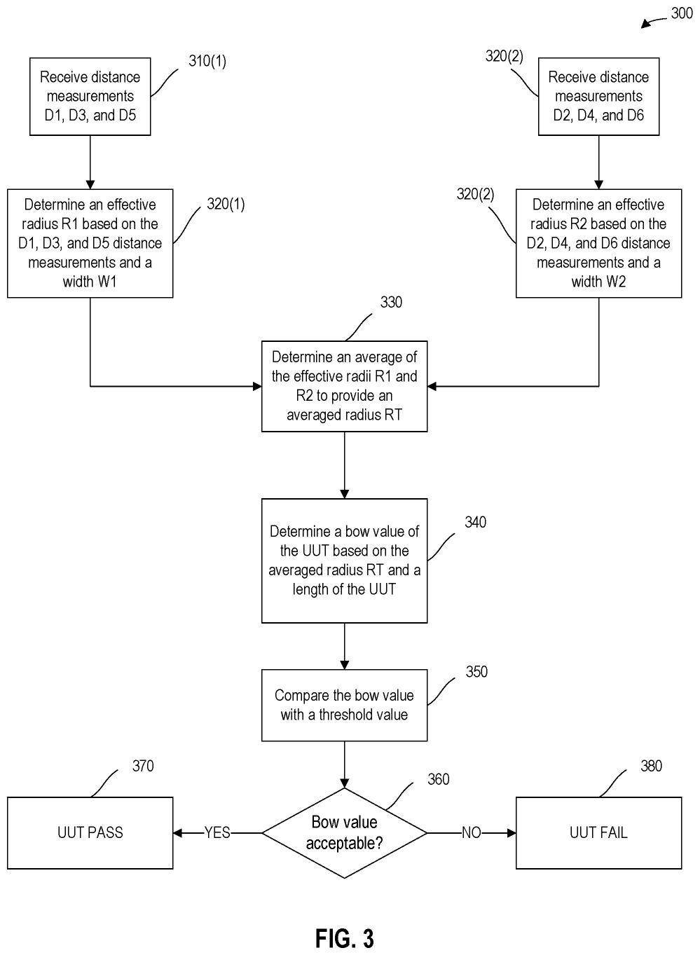

FIG. 3 depicts a flowchart for a method 300 to determine bow of a unit under test in accordance with embodiments of the disclosure. The method 300 may be performed by the system 100 of FIG. 1, the effective radius calculator 220(1) and/or the bow value calculator 230(1) of FIG. 2A, the effective radius calculator 220(2) and/or the bow value calculator 230(2) of FIG. 2B, the bow value calculator 230(T) of FIG. 2C, or any combination thereof.

The method 300 may include receiving distance measurements D1, D3, and D5, at 310(1), and receiving distance measurements D2, D4, and D6, at 310(2). The D1-D6 measurements may be provided from ultrasonic ranging devices, such as the ultrasonic ranging devices 110(1)-(6) of FIG. 1. The distance measurements D1-D6 may represent a respective distance to a UUT, such as the UUT 104 of FIG. 1. The distance measurements D1-D6 may be received by a bow calculation tool, such as the bow calculation tool 120 of FIG. 1.

The method 300 may further include determining an effective radius R1 based on the distance measurements D1, D3, and D5 and a width (e.g., the width W1 of FIGS. 1 and 2A) between the ultrasonic ranging devices that provided the D1, D3, and D5 distance measurements, at 320(1). The method 300 may further include determining an effective radius R2 based on the distance measurements D2, D4, and D6 and a width (e.g., the width W2 of FIGS. 1 and 2B) between the ultrasonic ranging devices that provided the D2, D4, and D6 distance measurements, at 320(2). The effective radius R1 and the effective radius R2 may be determined using respective radius calculators, such as the effective radius calculator 220(1) of FIG. 2A and the effective radius calculator 220(2) of FIG. 2B, respectively.

The method 300 may further include determining an average of the effective radius R1 and the effective radius R2 to provide an averaged radius RT, at 330. The averaged radius may be determined using an averager, such as the averager 231 of FIG. 2C.

The method 300 may further include determining a bow value of the UUT based on the averaged radius RT and a length of the UUT, at 340. The bow value may be determined using a bow calculator, such as the bow calculator bow value calculator 230(T) of FIG. 2C. In other examples, bow values based only on the effective radius R1 or the effective radius R2 may be determined using other bow calculators, such as the bow value calculator 230(1) of FIG. 2A or the bow value calculator 230(2) of FIG. 2B, respectively.

The method 300 may further include comparing the bow value to a threshold value, at 350. The method 300 may provide a pass/fail signal that indicates that the UUT passes, at 370, in response to a determination that the bow value is acceptable, at 360. The method 300 may provide the pass/fail signal that indicates that the UUT fails, at 380, in response to a determination that the bow value is unacceptable, at 360. In some examples, the pass/fail signal may only be set to pass when the bow value falls below or is equal to the threshold value. In other examples, the pass/fail signal may only be set to pass when the bow value is equal to or exceeds the threshold value. In yet other examples, the pass/fail signal may only be set to pass when the bow value is within a range defined by the threshold value.

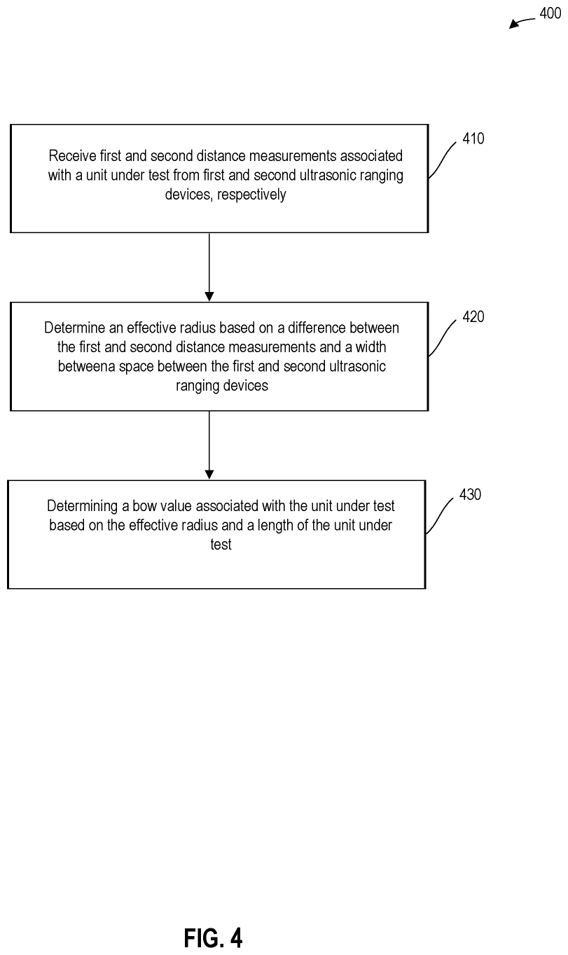

FIG. 4 depicts a flowchart for a method 400 to determine bow of a unit under test in accordance with embodiments of the disclosure. The method 400 may be performed by the system 100 of FIG. 1, the effective radius calculator 220(1) and/or the bow value calculator 230(1) of FIG. 2A, the effective radius calculator 220(2) and/or the bow value calculator 230(2) of FIG. 2B, the bow value calculator 230(T) of FIG. 2C, or any combination thereof.

The method 400 may include receiving first and second distance measurements associated with a unit under test from first and second ultrasonic ranging devices, respectively, at 410. The first and second ultrasonic ranging devices may include any of the ultrasonic ranging devices 110(1)-(6) of FIG. 1. The first and second distance measurements may represent a respective distance to a UUT, such as the UUT 104 of FIG. 1.

The method 400 may further include determining an effective radius based on a difference between the first and second distance measurements and a space between the first and second ultrasonic ranging devices, at 420. In some examples, the method 400 may further include receiving a third distance measurement associated with the unit under test from a third ultrasonic ranging device, and determining the effective radius further based on a difference between the first distance measurement and an average of the second and third distance measurements. In some examples, the method 400 may further include receiving a third distance measurement associated with the unit under test from a third ultrasonic ranging device, and determining the effective radius further based on a difference between the first distance measurement and an average of the second and third distance measurements. In some examples, the method 400 may further include determining an average of the first effective radius and the second effective radius to determine the bow value. The average radius may be determined using an averager, such as the averager 231 of FIG. 2C.

The method 400 may further include determining a bow value associated with the unit under test based on the effective radius and a length of the unit under test, at 430. In some examples, the method 400 may further include receiving third and fourth distance measurements associated with a unit under test from third and fourth ultrasonic ranging devices, respectively. In some examples, the method may further include determining a second effective radius based on a difference between third and fourth distance measurements received from third and fourth ultrasonic ranging devices and a space between the third and fourth ultrasonic ranging devices, and determining the bow value associated with the unit under test further based on the first effective radius, the second effective radius, and the length of the unit under test.

In some examples, the method 400 may further include determining whether the unit under test passes or fails to meet a standard based on the bow value. In some examples, the method 400 may further include comparing the bow value with a threshold value associated with the standard defined by the threshold value.

In some examples, the methods 300 and 400 may be implemented as computer executable instructions that are configured to cause a computing device to perform the methods 300 and 400.

Various illustrative components, blocks, configurations, modules, and steps have been described above generally in terms of their functionality. Persons having ordinary skill in the art may implement the described functionality in varying ways for each particular application, but such implementation decisions should not be interpreted as causing a departure from the scope of the present disclosure.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as previously described.

What is claimed is:

1. An apparatus, comprising:
a bow calculation tool configured to receive first and second distance measurements associated with a unit under test from first and second ultrasonic ranging devices, respectively, wherein the bow calculation tool is configured to determine an effective radius based on a difference between the first and second distance measurements and a space between the first and second ultrasonic ranging devices, wherein the bow calculation tool is further configured to determine a bow value associated with the unit under test based on the effective radius and a length of the unit under test.

2. The apparatus of claim 1, wherein the bow calculation tool is further configured to receive a third distance measurement associated with the unit under test from a third ultrasonic ranging device, wherein the bow calculation tool is configured to determine the effective radius further based on a difference between the first distance measurement and an average of the second and third distance measurements

3. The apparatus of claim 1, wherein the effective radius is a first effective radius, wherein the bow calculation tool is further configured to determine a second effective radius based on a difference between third and fourth distance measurements received from third and fourth ultrasonic ranging devices, respectively, and a space between the third and fourth ultrasonic ranging devices, wherein the bow calculation tool is configured to determine the bow value associated with the unit under test based further on the first effective radius, the second effective radius, and the length of the unit under test.

4. The apparatus of claim 3, wherein the bow calculation tool is further configured to receive the third and fourth distance measurements associated with the unit under test from the third and fourth ultrasonic ranging devices, respectively.

5. The apparatus of claim 3, wherein the bow calculation tool is configured to determine an average of the first effective radius and the second effective radius to determine the bow value.

6. The apparatus of claim 1, wherein the bow calculation tool is further configured to determine whether the unit under test passes or fails to meet a standard defined based on the bow value.

7. The apparatus of claim 6, wherein the bow calculation tool is further configured to compare the bow value with a threshold value associated with the standard.

8. A method, comprising:
receiving first and second distance measurements associated with a unit under test from first and second ultrasonic ranging devices, respectively;
determining an effective radius based on a difference between the first and second distance measurements and a space between the first and second ultrasonic ranging devices; and
determining a bow value associated with the unit under test based on the effective radius and a length of the unit under test.

9. The method of claim 8, further comprising:
receiving a third distance measurement associated with the unit under test from a third ultrasonic ranging device; and
determining the effective radius further based on a difference between the first distance measurement and an average of the second and third distance measurements.

10. The method of claim 8, wherein the effective radius is a first effective radius, the method further comprising:
determining a second effective radius based on a difference between third and fourth distance measurements received from third and fourth ultrasonic ranging devices and a space between the third and fourth ultrasonic ranging devices; and
determining the bow value associated with the unit under test further based on the first effective radius, the second effective radius, and the length of the unit under test.

11. The method of claim 10, further comprising receiving third and fourth distance measurements associated with a unit under test from third and fourth ultrasonic ranging devices, respectively.

12. The method of claim 10, further comprising determining an average of the first effective radius and the second effective radius to determine the bow value.

13. The method of claim 8, further comprising determining whether the unit under test passes or fails to meet a standard based on the bow value.

14. The method of claim 13, further comprising comparing the bow value with a threshold value associated with the standard defined by the threshold value.

15. A system, comprising:
a first set of ultrasonic ranging devices aligned along a first axis and oriented toward a second axis perpendicular to the first axis, wherein each ultrasonic ranging device of the first set of ultrasonic ranging devices is spaced apart from an adjacent ultrasonic ranging device of the first set of ultrasonic ranging devices by a first space, wherein the first set of ultrasonic ranging devices are configured to determine first respective distances to a unit under test along the second axis;
a second set of ultrasonic ranging devices aligned along the first axis and oriented toward the second axis perpendicular to the first axis, wherein each ultrasonic ranging device of the second set of ultrasonic ranging devices is spaced apart from an adjacent ultrasonic ranging device of the second set of ultrasonic ranging devices by a second space, wherein the second set of ultrasonic ranging devices are configured to determine second distances to the unit under test along the second axis; and
a bow calculation tool configured to receive the first respective distances from the first set of ultrasonic ranging devices and the second respective distances from the second set of ultrasonic ranging devices, wherein the bow calculation tool is configured to determine a first effective radius based the first respective distances and the first space and to determine a second effective radius based the second respective distances and the second space, wherein the bow calculation tool is further configured to determine a bow value associated with the unit under test based on the first effective radius, the second effective radius, and a length of the unit under test.

16. The system of claim 15, wherein the bow calculation tool is configured to determine the first effective radius based a difference between a first distance of the first respective distances and an average of two other distances of the first respective distances.

17. The system of claim 15, wherein the bow calculation tool is configured to determine an average of the first effective radius and the second effective radius to determine the bow value.

18. The system of claim 15, wherein the bow calculation tool is further configured to determine whether the unit under test passes or fails to meet a standard.

19. The system of claim 18, wherein the bow calculation tool is further configured to compare the bow value with a threshold value associated with the standard.

20. The system of claim 19, wherein the threshold value is less than or equal to 1/32 inches per foot.
